(19) United States
(12) Patent Application Publication
(10) Pub. No.: US 2013/0075340 A1
(43) Pub. Date: Mar. 28, 2013

(54) OIL SANDS FINE TAILINGS FLOCCULATION USING DYNAMIC MIXING

(71) Applicants: BARRY BARA, Edmonton (CA); SIMON YUAN, Edmonton (CA); RON SIMAN, Edmonton (CA); CLARA GOMEZ, Vancouver (CA)

(72) Inventors: BARRY BARA, Edmonton (CA); SIMON YUAN, Edmonton (CA); RON SIMAN, Edmonton (CA); CLARA GOMEZ, Vancouver (CA)

(73) Assignee: SYNCRUDE CANADA LTD. in trust for the owners of the Syncrude Project, Fort McMurray (CA)

(21) Appl. No.: 13/620,121

(22) Filed: Sep. 14, 2012

Related U.S. Application Data
(60) Provisional application No. 61/535,862, filed on Sep. 16, 2011.

(51) Int. Cl. C02F 1/56

(52) U.S. Cl. CPC C02F 1/56
USPC 210/710; 210/729; 210/734; 210/731; 210/735

(57) ABSTRACT

A process for flocculating and dewatering oil sands fine tailings is provided, comprising: adding the oil sands fine tailings as an aqueous slurry to a stirred tank reactor; adding an effective amount of a polymeric flocculant to the stirred tank reactor containing the oil sands fine tailings and operating the reactor at an impeller tip speed for a period of time that is sufficient to form a gel-like structure; subjecting the gel-like structure to shear conditions in the stirred tank reactor for a period of time sufficient to break down the gel-like structure to form flocs and release water; and removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

### FIELD OF THE INVENTION

The present invention relates to flocculation of oil sands fine tailings and dewatering of same using a flocculating polymer and dynamic mixing.

### BACKGROUND OF THE INVENTION

Oil sands are basically a combination of clay, sand, water and bitumen. Oil sands are mined by open pit mining and the bitumen is extracted from the mined oil sand using variations of the Clark Hot Water Process, where water is added to the mined oil sand to produce an oil sand slurry. The oil sand slurry is further processed to separate the bitumen from the rest of the components. The remaining solids, known as tailings, are sent to large ponds where the tailings separate into three primary layers: a top layer which is primarily water that is recycled back to the extraction process; a bottom layer primarily comprised of sand, which easily settles to the bottom; and a middle layer comprised of water, fine clays and hydrocarbons. The middle layer does not settle very quickly, as the clays essentially remain in suspension. Over time, the middle layer creates mature fine tailings or fluid fine tailings (FFT), which have an average solids content of about 30-40 wt %.

As mentioned above, the main issue with FFT is that it will not separate in a reasonable amount of time. In fact, it may take decades for FFT to thicken and dewater. Thus, containment of FFT in a large area is required. Hence, it is desirable to be able to dewater or solidify the FFT so as to be able to more economically dispose of or reclaim the fine tailings.

One recent method for dewatering FFT is disclosed in PCT application WO 2011/032258, which describes in-line addition of a flocculant solution into the flow of oil sands fine tailings, including FFT, through a conduit such as a pipeline. A pipeline reactor is disclosed comprising a co-annular injection device for in-line injection of the flocculating liquid within the oil sands fine tailings. Once the flocculant is dispersed into the oil sands fine tailings, the flocculant and fine tailings continue to mix as it travels through the pipeline and the dispersed fine clays bind together (flocculate) to form larger structures (flocs) that can be efficiently separated from the water when ultimately deposited in a deposition area.

In-line dispersion and mixing is commonly referred to as static mixing and the degree of mixing and shearing is dependent upon the flow rate of the materials through the pipeline. Thus, any changes in the fluid properties or flow rate of the oil sands fine tailings may have an effect on both mixing and shearing and ultimately flocculation. As stated in WO 2011/032258, shear conditioning is managed by adjusting the length of the pipeline through which the flocculated oil sands fine tailings travel prior to deposition. Thus, if one has a static length of pipe, it would be difficult to control flocculation because of the difficulty in independently controlling both the shear rate and residence time simply by changing the flow rate.

Other prior art (e.g., Canadian Patent Application No. 2,512,324) suggest addition of water-soluble polymers to oil sands fine tailings during the transfer of the tailings as a fluid to a deposition area, for example, while the tailings are being transferred through a pipeline or conduit to a deposition site. However, once again, proper mixing of polymer flocculant with tailings is difficult to control due to changes in the flow rate and fluid properties of the tailings material through the pipeline.

It is desirable to have a process which is readily controllable in order to accommodate differing oil sands fine tailings properties and differing flocculant solution properties while still maintaining good mixing and floc structure preservation.

### SUMMARY OF THE INVENTION

It has been discovered that proper mixing of a flocculant such as a high molecular weight nonionic, anionic, or cationic polymer with oil sands fine tailings such as FFT is critical to creating the right floc structure that will dewater the tailings rapidly. It is contemplated that the present invention can be used in conjunction with centrifugation of the flocculated fine tailings in, for example, decanter centrifuges; thickening of the flocculated fine tailings in thickeners known in the art; accelerated dewatering, or rim ditching, in specially constructed dewatering cells; and “thin lift” operations, where the flocculated fine tailings are spread over an area in a thin layer for rapid dewatering, followed by additional layering and dewatering of flocculated fine tailings.

It has been discovered that using a stirred tank reactor, which is commonly referred to as a dynamic mixer, to continuously mix oil sands fine tailings with a water-soluble flocculating polymer results in a more consistent production of well-defined floc structures which results in good dewatering. In one embodiment, the water-soluble polymer is used as an aqueous solution. Some advantages of using a dynamic mixer include the ability to control the mixing energy input independent of the feed flow rate; it is a more reliable operation; and it results in more robust flocculation performance (i.e., more robust flocs). The ability to control the energy input allows one to obtain the optimal operation regime for floc formation, as above or below the optimal operation regime could result in over-shearing or under-mixing of the mixture of FFT and flocculant solution, both of which result in poor water release.

Further, use of a stirred tank reactor allows the operator to control the mixing time (i.e., residence time) of the flocculant to more readily ensure a more robust flocculation performance without over-shearing or under-mixing.

It is understood that oil sands fine tailings means tailings that are derived from oil sands extraction operations which contain a fines fraction. Fines are generally defined as solids having a diameter less than 44 microns. An example of fines tailings useful in the present invention are mature fine tailings or fluid fine tailings (FFT) from tailings ponds. However, any fine tailings that are obtained from ongoing extraction operations may be used in the present invention. For example, the fine tailings can be obtained from a hydrocyclone. In one embodiment, fine tailings may be combined with coarse particles such as sand prior to treatment in a dynamic mixer.

In one aspect of the invention, a process for flocculating oil sands fine tailings is provided, comprising:
adding the oil sands fine tailings as an aqueous slurry to a stirred tank reactor having at least one impeller;
adding an effective amount of a polymeric flocculant to the stirred tank reactor containing the oil sands fine tailings and rotating the at least one impeller at an impeller tip speed for a period of time that is sufficient to cause the tailings to form a gel-like structure;
subjecting the gel-like structure to shear conditions in the stirred tank reactor for a period of time that is sufficient to break down the gel-like structure to form flocs and release water without overshearing; and
removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

This was discovered that impeller tip speed and mixing time are critical for mixing polymeric flocculant and oil sands fine tailings to produce optimum floc structures for maximum oil sands fine tailings dewatering.

In one embodiment, the removed flocculated oil sands fine tailings are added to at least one centrifuge to dewater the oil sands fine tailings and form a high solids cake and a low solids centrate.

In another embodiment, the removed flocculated oil sands fine tailings are added to a thickener to dewater the oil sands fine tailings and produce thickened oil sands fine tailings and clarified water.

In another embodiment, the removed flocculated oil sands fine tailings are transported to at least one deposition cell for dewatering.

In another embodiment, the removed flocculated oil sands fine tailings are spread as a thin layer onto a deposition site.

The oil sands fine tailings can have a solids content of about 10% to about 70%, more specifically, about 15% to about 45%, in particular when the oil sands fine tailings are fluid fine tailings (FFT). In one embodiment, the FFT are diluted to about 20% solids content.

In one embodiment, the polymeric flocculant is a water soluble polymer having a moderate to high molecular and an intrinsic viscosity of at least about 3 dl/g (measured in 1M NaCl at 25° C.). The polymeric flocculant may be cationic, non-ionic, amphoteric, or anionic. The polymeric flocculant can be in an aqueous solution at a concentration of about between 0.05 and 5% by weight of polymeric flocculant. Typically, the polymeric flocculant solution will be used at a concentration of about 1 g/L to about 5 g/L.

Suitable doses of polymeric flocculant can range from 10 grams to 10,000 grams per tonne of oil sands fine tailings. Preferred doses range from about 400 to about 1,000 grams per tonne of oil sands fine tailings.

In one embodiment, the stirred tank reactor can be either a single stage mixer or a multistage mixer.

### BRIEF DESCRIPTION OF THE DRAWINGS

FIG. 1 is a schematic of embodiments A to D of the process of the present invention.

FIG. 2 is a schematic of one embodiment of a stirred tank reactor (also referred to as a dynamic mixer) of the present invention.

FIG. 3 is a graph of fines capture in the centrifuge cake of a Lynx 60 centrifuge when fed FFT flocculated with 750-850 g/tonne polymer in a dynamic mixer versus dynamic mixer impeller speed (RPM).

FIG. 4 is a graph of solids (fines) present in the centrate of a Lynx 60 centrifuge when fed FFT flocculated with 750-850 g/tonne polymer in a dynamic mixer versus dynamic mixer impeller speed (RPM).

FIG. 5a is a photograph of flocculated FFT removed from a dynamic mixer where the impeller speed was 73 RPM.

FIG. 5b is a photograph of flocculated FFT removed from a dynamic mixer where the impeller speed was 112 RPM.

FIG. 6 is a graph showing dewatering (CST) versus impeller tip speed (maximum shear) times the number of turnovers of FFT slurry.

FIG. 7 is a scatter plot of Capillary Suction Time (s) versus yield stress (Pa) for 42 FFT samples after being mixed in a dynamic mixer with 750-850 g/tonne polymer.

FIG. 8a shows one of sample of treated FFT, where the flocculated FFT showed strong flocs and had a yield stress of 45 Pa and a Capillary Suction Time of 100.6 sec.

FIG. 8b shows another sample of treated FFT, where the flocculated FFT showed much weaker flocs and had a yield stress of only 15.3 Pa and a Capillary Suction Time of 283 sec.

FIG. 9 is a graph of fines capture in the centrifuge cake of a Lynx 60 centrifuge when fed FFT flocculated with 750-850 g/tonne polymer in a dynamic mixer versus Capillary Suction Time (s).

FIG. 10 is a graph of fines capture in the centrifuge cake of a Lynx 60 centrifuge when fed FFT flocculated with 750-850 g/tonne polymer in a dynamic mixer versus yield stress (Pa).

FIG. 11 is a graph of fines capture in a centrifuge cake of a Lynx 60 centrifuge as a function of polymer dose added to FFT in a dynamic mixer operating at an impeller speed of 73 RPM.

FIG. 12 is a graph showing the flocculation process for 20 wt % FFT.

FIG. 13 is a graph showing the flocculation process for 35.8 wt % FFT.

FIG. 14 is a plot of Power number (NP) versus modified Reynolds number (Re′) for flocculated FFT and analogue carbopol solution.

FIGS. 15a, 15b and 15c are simulations of FFT and polymer in a dynamic mixer at impeller speeds of low RPM, medium RPM and high RPM, respectively.

FIG. 16 is a schematic of another embodiment of a stirred tank reactor (also referred to as a dynamic mixer) of the present invention.

FIG. 17a is a plot of yield stress versus post-flocculant shear time when using flocculant SNF 3335 for three different mixing powers per unit volume of slurry.

FIG. 17b is a plot of yield stress versus post-flocculant shear time when using flocculant SNF 3338 for two different mixing powers per unit volume of slurry.

FIG. 18a is a plot of CST (sec) versus post-flocculant shear time when using flocculant SNF 3335 for three different mixing powers per unit volume of slurry.

FIG. 18b is a plot of CST (sec) versus post-flocculant shear time when using flocculant SNF 3338 for three different mixing powers per unit volume of slurry.

FIG. 19 is a plot of yield stress versus post-flocculant shear time when using flocculant SNF 3335 for five different flocculant injection/mixing times.

FIG. 20 is a plot of CST (sec) versus post-flocculant shear time when using flocculant SNF 3335 for five different flocculant injection/mixing times.

FIG. 21 is a plot of Centrate Solids % versus post-flocculant shear time when using flocculant SNF 3335 for five different flocculant injection/mixing times.

FIG. 22 is a plot of yield stress versus post-flocculant shear time when using flocculant SNF 3338 for four different flocculant injection/mixing times.

FIG. 23 is a plot of CST (sec) versus post-flocculant shear time when using flocculant SNF 3338 for four different flocculant injection/mixing times.

FIG. 24 is a plot of Centrate Solids % versus post-flocculant shear time when using flocculant SNF 3338 for four different flocculant injection/mixing times.

FIG. 25 shows the change in dewatering (Delta CST) of well flocculated oil sands fine tailings when subjected to additional shear in a pipeline.

FIG. 26 compares both fines capture (%) and centrate solids (%) versus tip speeds, m/sec.

FIG. 27 shows the effect of SNF 3335 dosages on yield stresses of flocculated materials.

FIG. 28 shows the effect of SNF 3335 dosages on CST of flocculated materials.

FIG. 29 shows the effect of SNF 3335 dosages on centrate solids content of flocculated materials.

FIG. 30 show the effect of SNF 3338 dosages on yield stresses of flocculated materials.

FIG. 31 shows the effect of SNF 3338 dosages on CST of flocculated materials.

FIG. 32 shows the effect of SNF 3338 dosages on centrate solids contents of flocculated materials.

### DETAILED DESCRIPTION OF EMBODIMENTS OF THE INVENTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a process for dewatering oil sands tailings. As used herein, the term “tailings” means tailings derived from oil sands extraction operations and containing a fines fraction. The term is meant to include fluid fine tailings (FFT) from tailings ponds and fine tailings from ongoing extraction operations (for example, thickener underflow or froth treatment tailings) which may bypass a tailings pond.

In one embodiment of the process of the present invention, the oil sands fine tailings are primarily FFT obtained from tailings ponds. The raw FFT will generally have a solids content of around 30 to 40 wt % and may be diluted to about 20-25 wt % with water for use in the present process. However, any oil sands fine tailings having a solids content ranging from about 10 wt % to about 70 wt % or higher can be used.

Useful flocculating polymers or “flocculants” include charged or uncharged polyacrylamides such as a high molecular weight polyacrylamide-sodium polyacrylate co-polymer with about 25-35% anionicity. The polyacrylamide-sodium polyacrylate co-polymers may be branched or linear and have molecular weights which can exceed 20 million.

As used herein, the term “flocculant” refers to a reagent which bridges the neutralized or coagulated particles into larger agglomerates, resulting in more efficient settling. Preferably, the polymeric flocculants are characterized by molecular weights ranging between about 1,000 kD to about 50,000 kD. Natural polymeric flocculants may also be used, for example, polysaccharides such as dextran, starch or guar gum.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

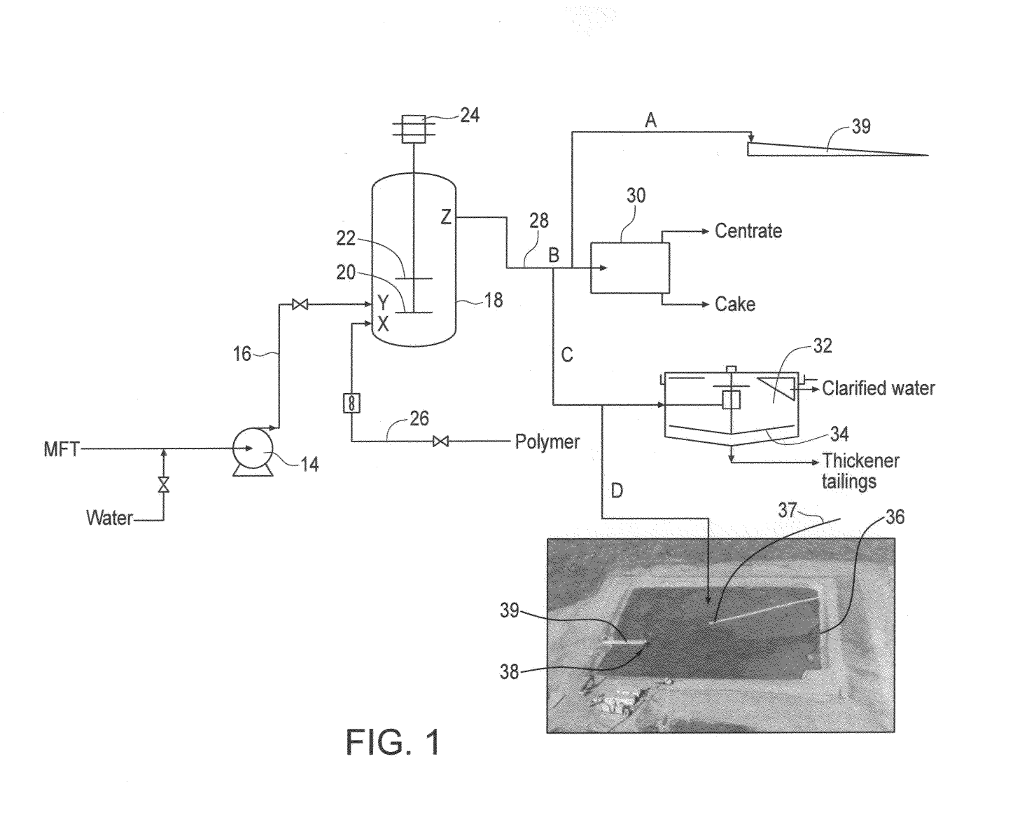

A schematic of four embodiments, A, B, C and D, of the present invention is shown in FIG. 1. Oil sands fine tailings, in this case, FFT, are dredged from a tailings pond (not shown) and pumped via pump 14 through line 16 and added at Point Y of dynamic mixer 18. Dynamic mixer 18 comprises two impellers, lower impeller 20 and upper impeller 22. It is understood that the size, location and number of impellers used in a dynamic mixer is dependent upon the overall dimensions (volume) of the dynamic mixer necessary for a particular operation. In one embodiment, the impeller diameter and height of the slurry in the mixer are both about 0.6 to 0.7 times the tank diameter.

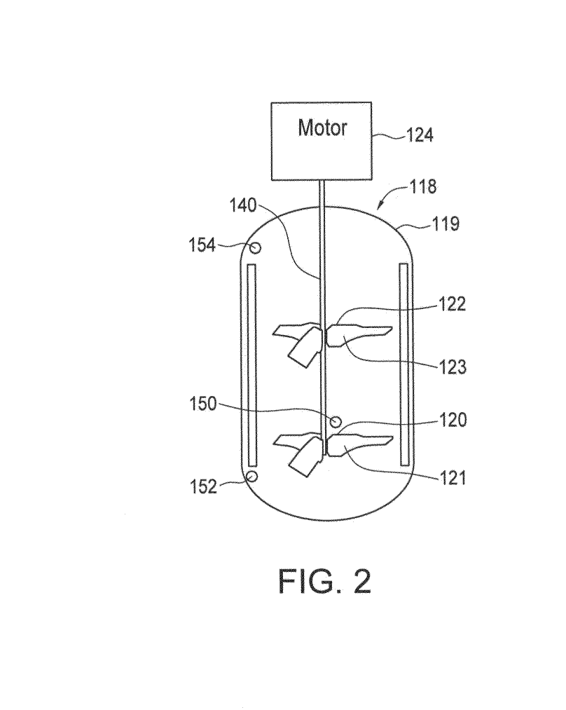

A flocculating polymer, such as an aqueous solution of an acrylamide-acrylate copolymer, is added via line 26 to Point X of the dynamic mixer 18. Generally, the polymer inlet and the FFT inlet are separated spatially, both vertically and horizontally (see FIG. 2). The impellers 20, 22 (shown here as hydrofoil impellers) are rotated by variable speed motor 24 to give optimum mixing of the FFT and polymer so that initially a gel-like structure is formed. Other useful impellers include flat blade turbine impellers and pitched blade turbine. The continued rotation of impellers 20, 22 provides shear conditioning to the gel-like structure to break up the gel-like structure into flocs, thereby allowing the water to flow more readily. However, overshearing must be prevented because overshearing can cause the flocs to be irreversibly broken down, resulting in resuspension of the fines in the water thereby preventing water release and drying.

In one embodiment (B) shown in FIG. 1, the flocculated FFT is removed near the top of dynamic mixer 18 at Point Z and transferred via line 28 to a centrifuge 30 such as a Lynx 60 Decanter Centrifuge by Alfa Laval. A centrifuge cake solid containing the majority of the fines and a relatively clear centrate having low solids concentrations are formed in the centrifuge 30. The centrifuge cake can then be transported, for example, by trucks, and deposited in a drying cell.

In another embodiment (A), the flocculated FFT is removed and transferred to a thin lift deposition site having a slope of about 2 to 4% to allow water drainage. This water drainage allows the material to dry at a more rapid rate and reach trafficability levels sooner. Additional layers can be added and allowed to drain accordingly.

In a further embodiment (C), the flocculated FFT is removed and placed in a thickener 32, which thickener 32 may comprise rakes 34, to produce clarified water and thickened tailings for further disposal.

In yet a further embodiment (D), the flocculated FFT is removed from the dynamic mixer 18 and deposited at a controlled rate via pipe 37 into an accelerated dewatering cell 36, which acts as a fluid containment structure. The water released is removed using pumps 38 and exits via pipe 39. The deposit fill rate is such that maximum water is released during deposition.

### EXAMPLE 1

FIG. 2 shows a stirred tank reactor design (i.e., dynamic mixer) that was used in this Example. As can be seen from FIG. 2, dynamic mixer 118 comprised a tank 119 (4 m³) with two hydrofoil impellers 120, 122 mounted on a single shaft 140. Each impeller 120, 122 consists of three impeller blades, 121 and 123, respectively. Polymer is continuously injected into the tank at polymer inlet 152 and FFT is continuously injected at the lower impeller level through FFT inlet 150 which comprised a quill that exited slightly past the tips of impeller blades 123. The flocculated FFT product is continuously withdrawn near the top of the dynamic mixer 118 from FFT outlet 154. Both impellers 120 and 122 are operated by motor 124.

In the following Example, dynamic mixer 118 was connected to a Lynx™ 60 Decanter Centrifuge as shown in embodiment B of FIG. 1. Samples of flocculated FFT were taken after the FFT exits outlet 154 and before centrifugation, i.e., a few meters before the Lynx™ 60, to test for vane yield stress, dewatering capability (Capillary Suction Time) and for visual floc structure observation. Further, since the dynamic mixer was connected to a centrifuge during testing, mixing performance of the system was also evaluated from the performance of the centrifuge, i.e., fines capture in the centrifuge cake solids and wt % solids in the centrate.

In each run, process conditions were first set and the system stabilized for about 30 minutes before collecting samples. As previously mentioned, when the dynamic mixer was connected to a centrifuge during testing, samples of the flocculated FFT were taken a few meters before the centrifuge. The polymer used in these experiments was a diluted solution (0.2 wt %) of a medium-high molecular weight (i.e., 14-20 million), branched chain anionic polymer (Polymer A) having approximately 25-30% charge density (an acrylamide/acrylate copolymer) and the polymer dosage ranged from about 750-850 g/tonne dry weight of tailings, unless otherwise noted. The flow rate of the FFT into the dynamic mixer was varied from 30-55 m³/hr during the testing.

One of the objectives of the following tests was to determine conditions under which (1) strong flocs were formed and (2) enhanced dewatering occurred.

In this test run, FFT, which had been diluted to about 20 wt % solids, and 750-850 g/tonne of Polymer A were added to a dynamic mixer as shown in FIG. 2. The dynamic mixer was located approximately 10-15 m upstream of a Lynx 60 centrifuge. Polymer A was injected at the bottom of the vessel as shown in FIG. 2. The fines capture in the centrifuge cake and solids content of the centrate from the Lynx 60 centrifuge were determined, both as a function of dynamic mixer impeller speed and as a function of the flow rate of the FFT into the dynamic mixer.

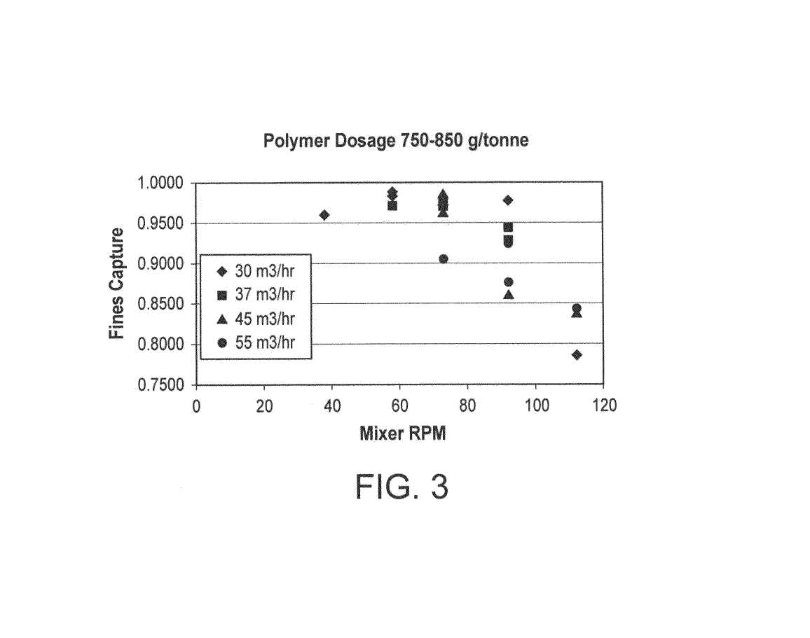

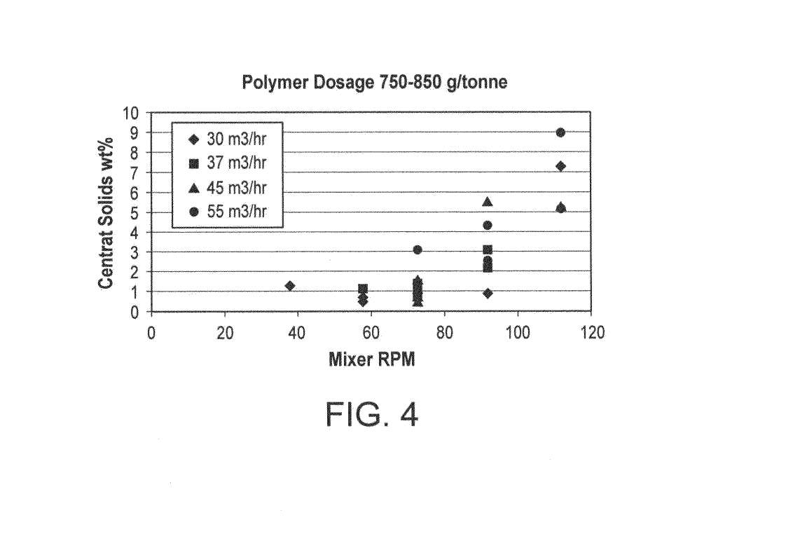

It can be seen from FIG. 3 that the fines capture, as represented by percent fines recovered in the cake, decreased as the impeller speed (shown in FIG. 3 as mixer RPM) increased above 73 RPM. This trend was shown for all flow rates. Thus, it would appear that mixing the flocculant polymer and FFT too vigorously may result in floc break down. Similarly, FIG. 4 shows that the centrate solids (wt %) also increased as the impeller speed increased above 73 RPM.

FIGS. 3 and 4 show that changes in flow rate of the FFT to the dynamic mixer did not appear to affect the mixing performance of the dynamic mixer and similar results could be obtained over the range of flow rates tested simply by adjusting the mixer RPM. Thus, it appears that the mixing energy is predominantly provided by the rotating impellers in a dynamic mixer and, as such, optimum flocculation is directly related to the impeller speed. Hence, contrary to static mixing, for example, in a pipeline, the energy input in the system is essentially decoupled from the flow rate in the case of the dynamic mixer. As a result, mixing energy into the system can be easily controlled by changing the speed of the impeller.

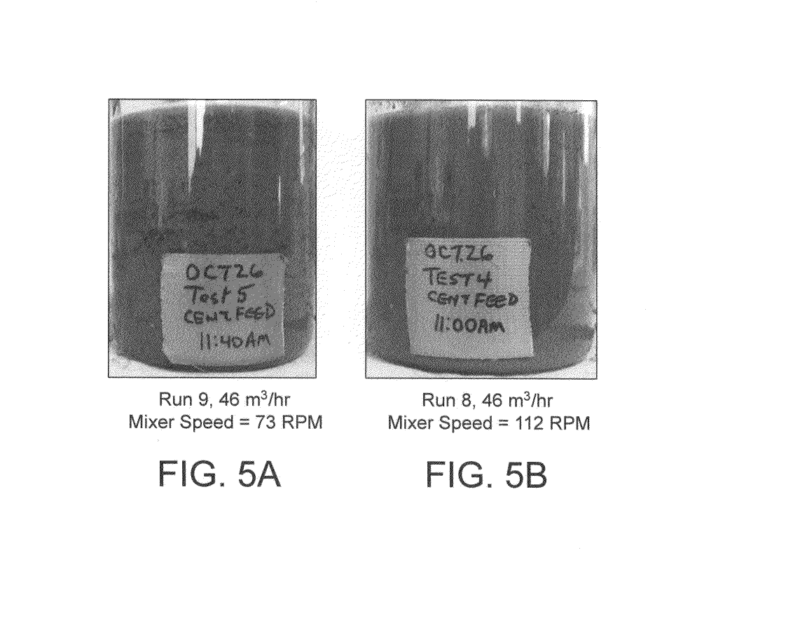

FIGS. 5a and 5b show the floc structure for the same material at an impeller speed of 73 RPM and at a higher impeller speed of 112 RPM, respectively. It can be seen in FIG. 5a that good flocs were formed, which resulted in a fairly well defined floc structure, which resulted in good dewatering. However, in FIG. 5b, where the impeller speed was 112 RPM, less floc structure is seen; this suggests that the performance decrease shown in FIGS. 3 and 4 is likely due to over-shearing of the floc structures. Thus, there appears to be an optimum rotational speed for flocculation somewhere between 40 to 75 RPM for this particular tank and impeller design. Above around 75 RPM there is a significant reduction in centrifuge performance, i.e., dynamic mixing performance, due to shearing of the flocs.

The vane yield stress and the dewaterability of the flocs formed in the dynamic mixer were also determined. Vane yield stress of the flocculated FFT was measured using a Brookfield, R/S Plus-Soft Solids Tester rheometer, which measures the stress required before the flocculated material starts to yield, and the dewatering ability of the flocculated FFT was measured using a Triton Electronics Ltd. Capillary Suction Time testers. Dewaterability is thus measured as a function of how long it takes for water to be suctioned through a filter and low values indicate rapid dewatering whereas high values indicate slow dewatering ability. Thus, a low CST number indicates good dewatering. Dewatering ability is hereinafter referred to as CST.

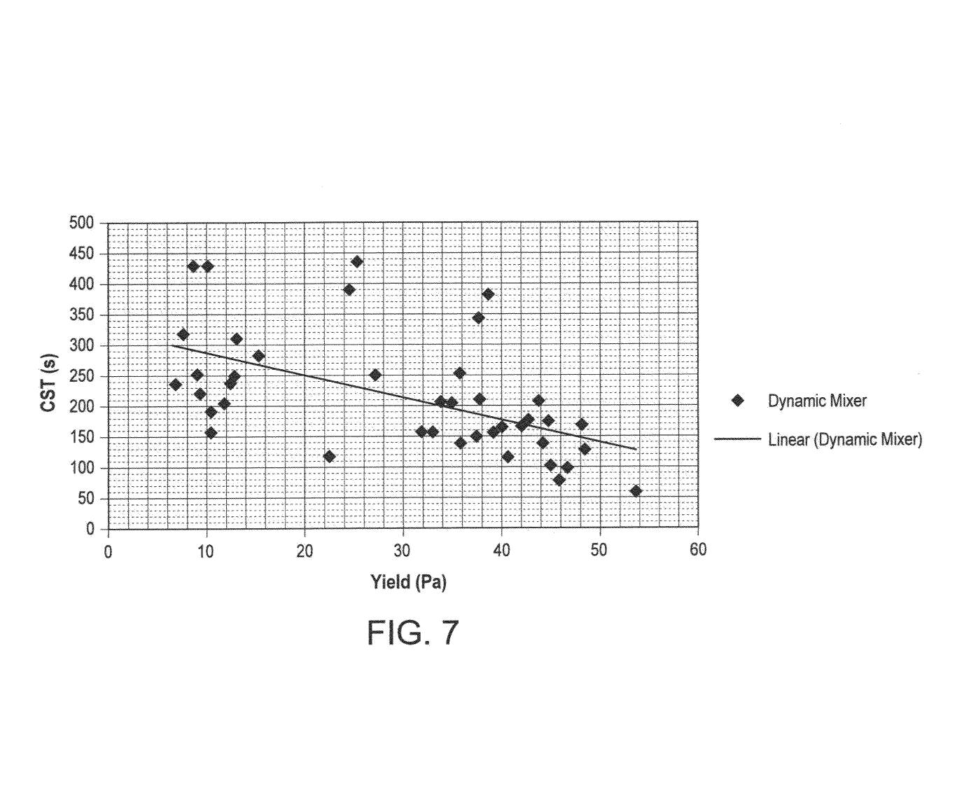

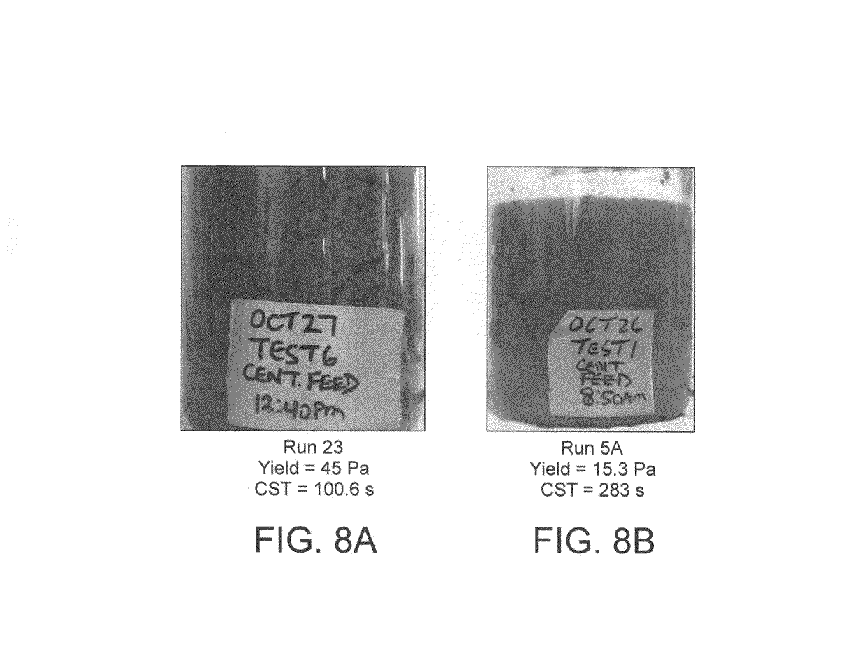

FIG. 7 shows a plot of shear yield (measured in Pa) versus CST of flocculated FFT obtained under varying impeller RPMs ranging from 38 RPM to 112 RPM (42 runs). The relationship between shear yield and good waterability can be seen in this graph. In general, it can be seen that as the yield stress of the flocculated FFT increases, the CST value decreases, indicating better floc structure which leads to better dewatering. A visual comparison of two runs, Run 23 and Run 5A, can be seen in FIGS. 8a and 8b, respectively. Run 23 had a higher yield stress (45 Pa vs. 15.3 Pa) and a lower CST (100.6 s vs. 283 s) than Run 5A. Thus, one would predict that the floc structure would be stronger in Run 23 versus Run 5A, which is what was visually observed, as shown in FIGS. 8a and 8b.

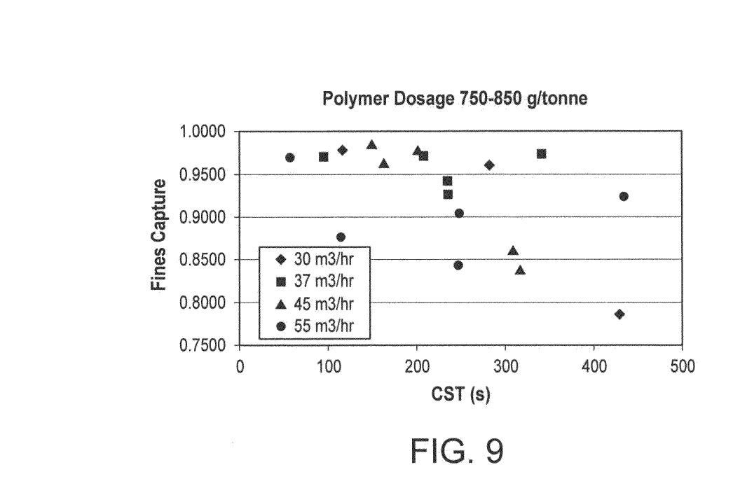

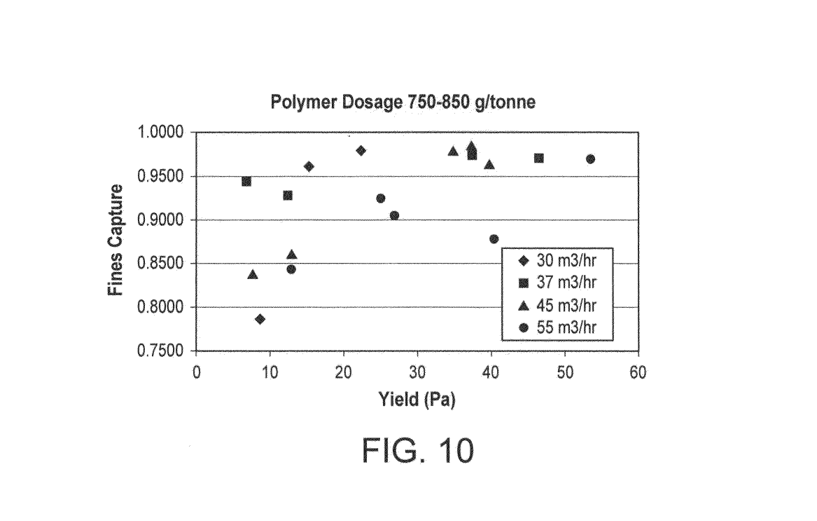

The dynamic mixer performance, as indicated by Fines Capture in the centrifuge cake, was plotted as a function of CST value and yield stress, which is shown in FIG. 9 and FIG. 10, respectively. In each run, the polymer dosage was 750-850 g/tonne and the flow rates varied from 30 m³/hr to 55 m³/hr. As can be seen in FIG. 9, as the dewatering improved (i.e., the CST decreased), more fines were captured in the centrifuge cake. Similarly, it can be seen in FIG. 10 that as the shear yield increased more fines were captured in the centrifuge cake.

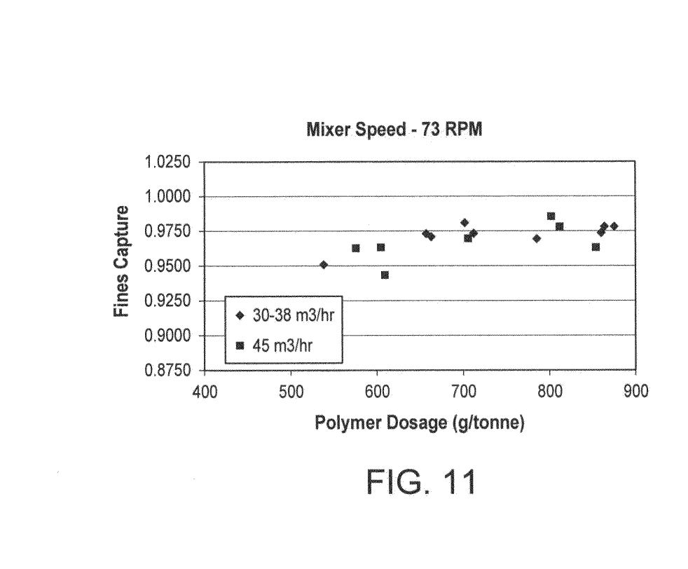

The preferred dosage of Polymer A, in grams of polymer per tonne of dry tailings, was determined by operating the dynamic mixer at the near optimal impeller speed of 73 RPM and adding between 500 to 875 g/tonne polymer to diluted FFT having a solids concentration of about 20 wt %. The flocculation performance was determined by measuring the fines capture in the cake formed in the Lynx 60 centrifuge. It can be seen in FIG. 11 that below about 700 g/tonne the flocculation performance starts to drop off From 700 g/tonne up to the highest level of almost 900 g/tonne, the flocculation performance is constant.

The flocculation process was further examined using two different FFT samples; one having a solids content of 35.8 wt % and one having a solids content of 20 wt %. In this Example, samples of FFT were taken from a dynamic mixer at various time periods (in minutes) post flocculant polymer addition. The torque, which is a measure of the turning force on the impeller, was plotted against time (in minutes) over the entire period of the test. The yield stress and CST were also measured at various time intervals after about 3.5 minutes of mixing of polymer and FFT.

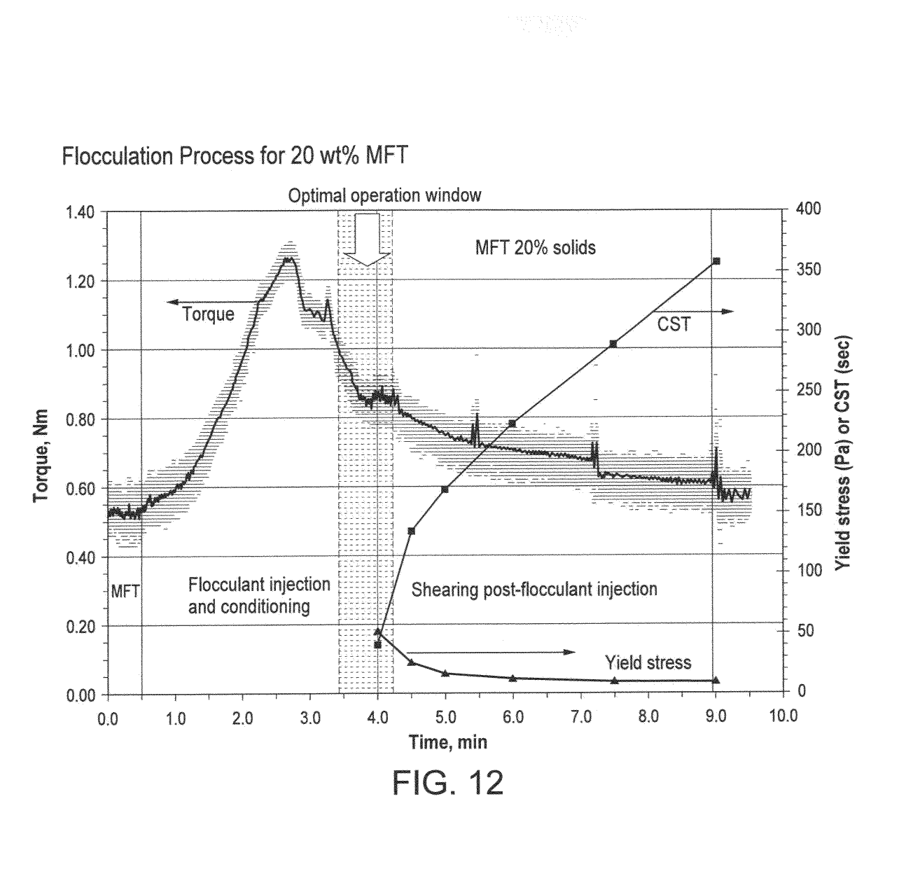

FIG. 12 shows the flocculation process for 20 wt % FFT. As expected, the torque increased quite sharply post flocculant injection for a period of about 2.5 minutes, which is consistent with the formation of a gel-like structure. After about 2.5 minutes post injection, torque started to decline, indicating the break-up of the gel-like structure into individual large flocs. After about 3.5 minutes post flocculant injection, yield stress was shown to begin declining as well and the CST values started to climb. This would indicate the period of over-shearing, where the large flocs may be irreversibly reduced to small flocs.

Thus, it would appear that the optimal operating window would be between about 3.5 and 4.2 minutes or about 3.0 to about 3.7 minutes post flocculant injection. As mentioned, the decrease in yield stress and increase in CST is likely due to excessive shear post-flocculant injection. This is in keeping with the theory that in the initial period post-injection of flocculant, the FFT is forming a gel-like structure. After a certain degree of shearing or conditioning of the gel-like structure, large flocs are formed allowing for maximum water release. However, after about 3.7 minutes, the shearing starts having a negative effect and the large flocs are irreversibly broken down and fines are released.

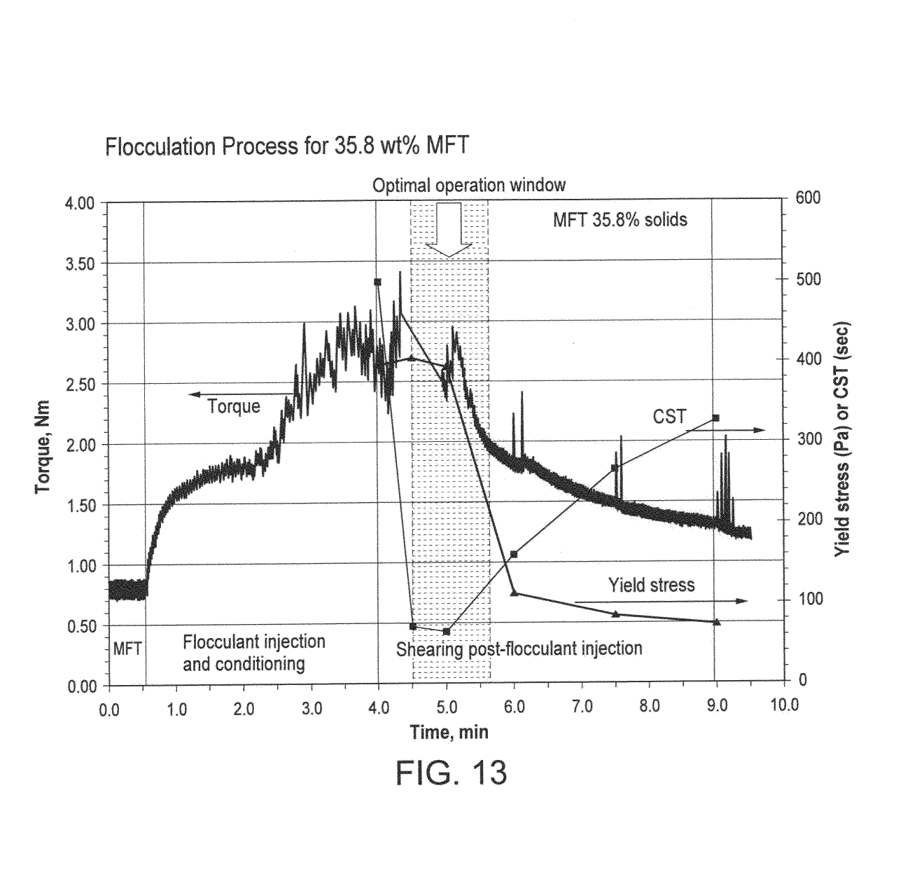

Similar results were obtained with 35.8 wt % FFT, as shown in FIG. 13. It can be seen that with a higher solids FFT, conditioning time required for good floc formation is slightly longer and yield stress doesn't start to decline until about 4.5 minutes post flocculant addition. Similarly, CST doesn't appear to start increasing until about the same time; i.e., about 4.5 minutes post flocculant addition. Thus, with more concentrated FFT, the optimal operation window is likely between about 4.0 to about 5.1 minutes post flocculant polymer addition.

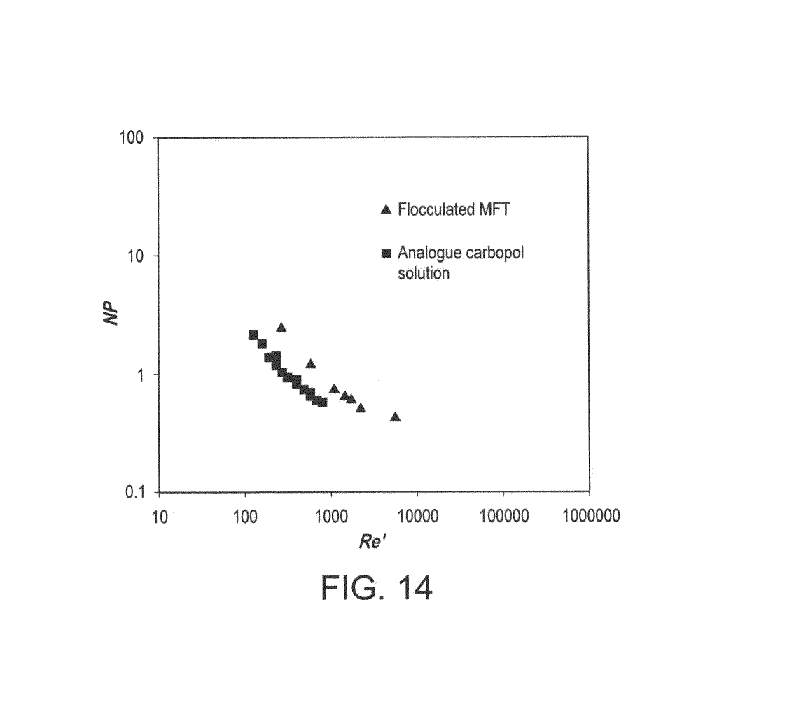

Based on the fluid properties of flocculated FFT obtained in the above tests, it was possible to determine a modified Reynolds number (e.g., Metzler Reed Reynolds number) for various flocculated FFT. A correlation of Power number (NP) and Reynolds number (Re′) is shown in FIG. 14. Thus, based on the plot of flocculated FFT (triangles), one can determine the power requirements for a given RPM to obtain properly flocculated FFT. FIG. 13 also shows a modified Reynolds number of an analogue carbopol solution versus Power number. Carbopol solution has flow yield stress behavior that is well known and doesn't break down. The plot for carbopol solution is similar to flocculated FFT, indicating similar behavior of carbopol solution and FFT.

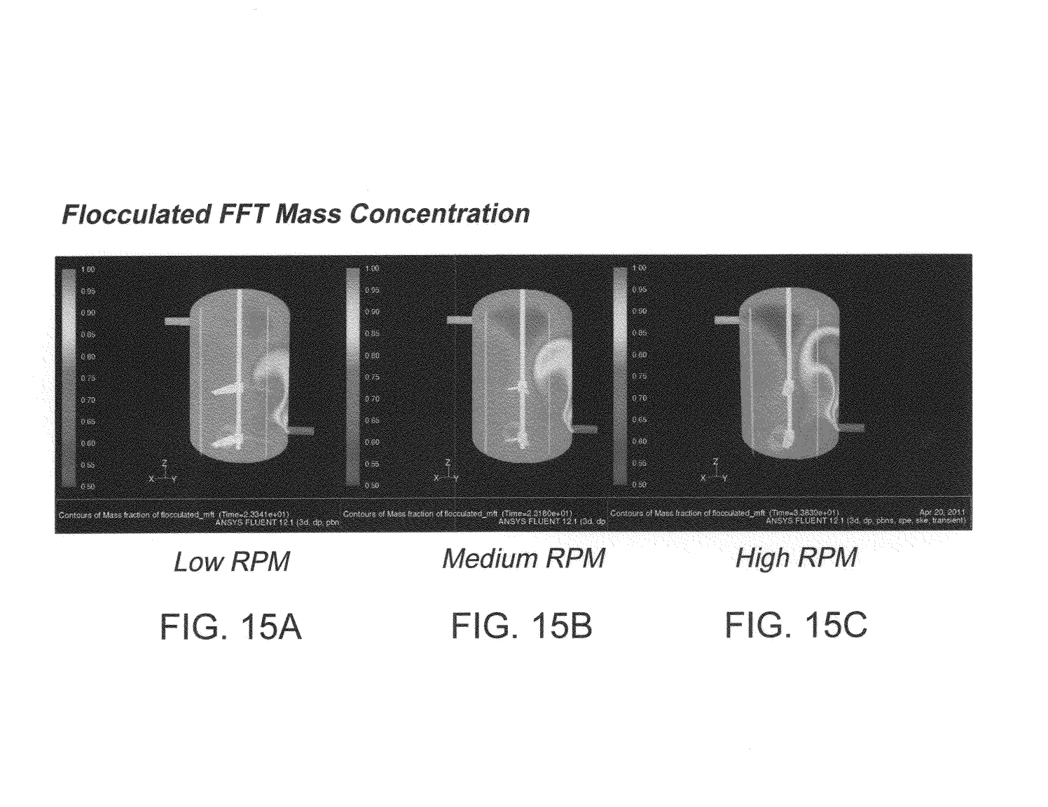

A simulation of the mixing behavior of FFT and polymer is shown in FIGS. 15a, 15b, and 15c. It can be seen that as the impeller speed increases from low RPM (FIG. 15a) to medium RPM (FIG. 15b) and high RPM (FIG. 15c), there is more shear at the impeller. As mentioned above, however, too much shear can cause flocs to irreversibly break down. Thus, these simulations show the importance of impeller speed for good floc formation and dewatering.

The above tests show that a dynamic mixer of the proper design can be used to mix FFT with a polymer to produce a well floccutated structure. A key aspect is that the shear imparted by the impeller must be in the right range as to provide adequate mixing without overshearing the flocs. Based on the above test work, this requires that the impeller diameter and height of fluid above the impeller both be about 0.6-0.7 times the tank diameter. The impeller speed must also be kept below a certain rpm depending on polymer dosage and FFT solids content to avoid overshearing of the flocs. This will usually result in the impeller operating in a transitional flow regime. Given the unique rheological properties of flocculated FFT, operation of a dynamic mixer outside of the above ranges resulted in poor dewatering. In addition, the dynamic mixer should be placed in close proximity to the dewatering stage.

### EXAMPLE 2

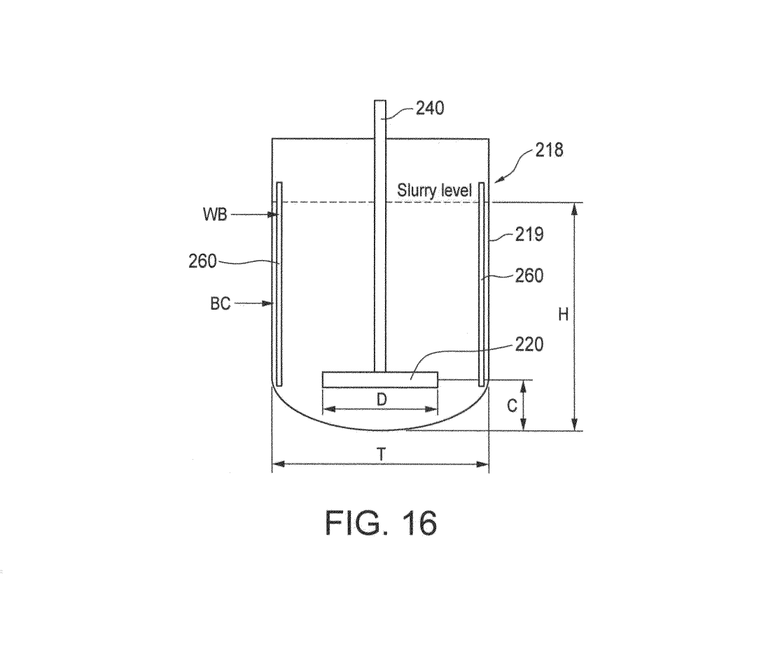

FIG. 16 illustrates another stirred tank reactor design (i.e., dynamic mixer) useful in the present invention. As can be seen from FIG. 16, dynamic mixer 218 comprises a tank 219 having a flat blade turbine 220 comprising six flat blades (not shown) mounted therein on a single shaft 240. Included in the tank 219 were baffles 260.

In the following tests, the tank 219 had a diameter (T) of 315-mm, the baffle clearance (BC) to the tank wall was about 10 mm, the clearance between the turbine 220 and the tank bottom (C) was 65 mm, and the width of the baffles (WB) was about 6 mm. It was discovered that if the ratio of slurry height (H) to tank (mixer) diameter (H/T) is too large (e.g., 1.2), the slurry load is too high and the slurry is hard to be homogeneously mixed. If the H/T is too low (e.g., 0.4), the floc structures that are formed in the mixer could be easily oversheared. Similarly, if the impeller diameter (D) to tank (mixer) diameter (D/T) is too small (e.g., 0.4), the slurry is not homogeneously mixed and if the D/T is too large (e.g., 0.8), the flocculated material could be easily oversheared.

Tests were done using two high molecular weight polymers, an linear anionic acrylamide/acrylate polymer (SNF 3335) having approximately 25-30% charge density and a branched anionic acrylamide/acrylate polymer (SNF 3338) having approximately 25-30% charge density. The FFT feed solids content was 20%, H/T 0.6, D/T 0.6 or 0.7, SNF 3335 flocculant concentration 0.17% and dosage 920 g/t, SNF 3338 flocculant concentration 0.4% and dosage 800 g/t, flocculant injection/mixing time of 3.5 minutes, and ambient temperature of 20° C. Three different power input per unit volume of slurry (P/V) were used, namely, 4 hp/kgal, 7 hp/kgal and 11 hp/kgal. Power input is related to the cube of the impellers' rotational speed. Power input per unit volume of slurry (P/V) can be calculated as follows:

$$P \text{/} V = \frac{{N}_{p} ρ {N}^{3} {D}^{5}}{V} ,$$

where P is power (HP); V is the slurry volume (m³); Nₚ is a power number (dimensionless) which depends upon the type of impellers used and the impeller Renoylds number; ρ is the slurry density (kg/m³); N is the rotational speed of the impellers (RPM); and D is the impeller diameter (m).

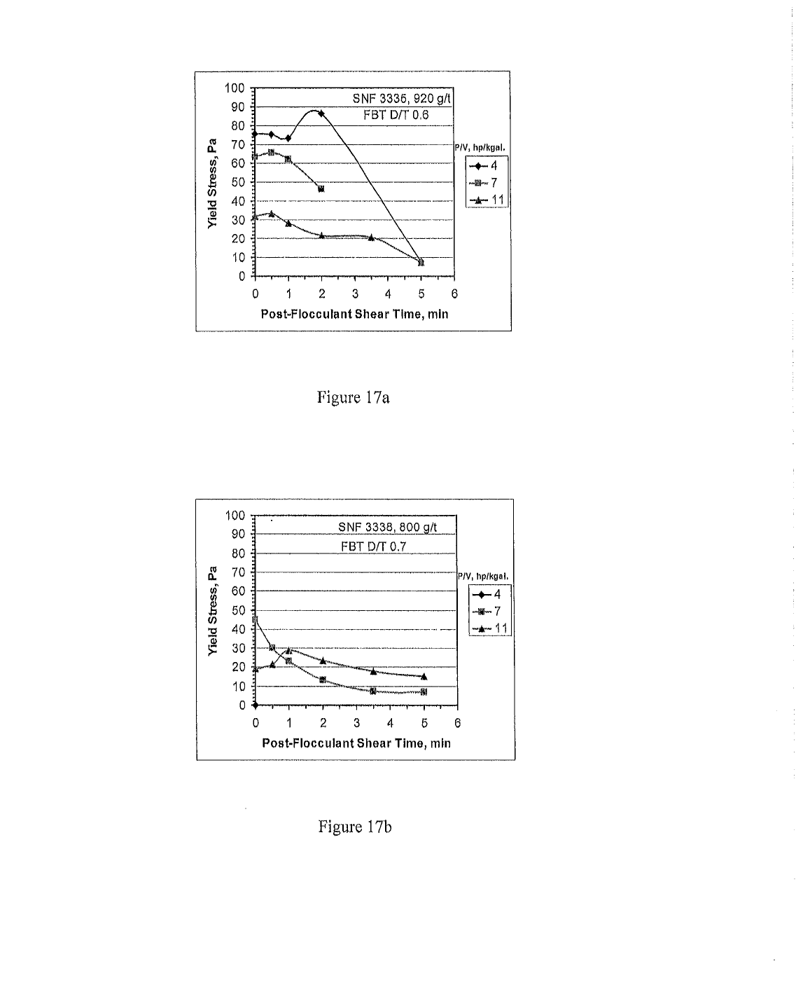

FIGS. 17a and 17b show that, after mixing the flocculant with the tailings for a duration of 3.5 minutes, continued application of power (i.e., continued mixing) resulted in a decrease in yireld stress. In particular, FIG. 17a shows that as the post-flocculant shear time increased, the yield stress decreased for all three mixing powers. Similarly, FIGS. 18a and 18b show the effect of mixing powers on CST at different post-flocculant shear time. It can be seen in FIG. 18a that within 2 minutes of post-flocculant shear time with SNF 3335, the CST values were less than 100 seconds for all three mixing powers. However, after 2 minutes, over-shearing of the flocculated materials led to longer CST and progressively worse dewatering capabilities. A similar trend was shown when using SNF 3338. It can be seen in FIG. 18b that after about 1 minute the CST increased at all three powers. However, the data in FIGS. 17b and 18b suggest that with SNF 3338 the mixing power of 7-11 hp/kgal resulted in better flocculation performances.

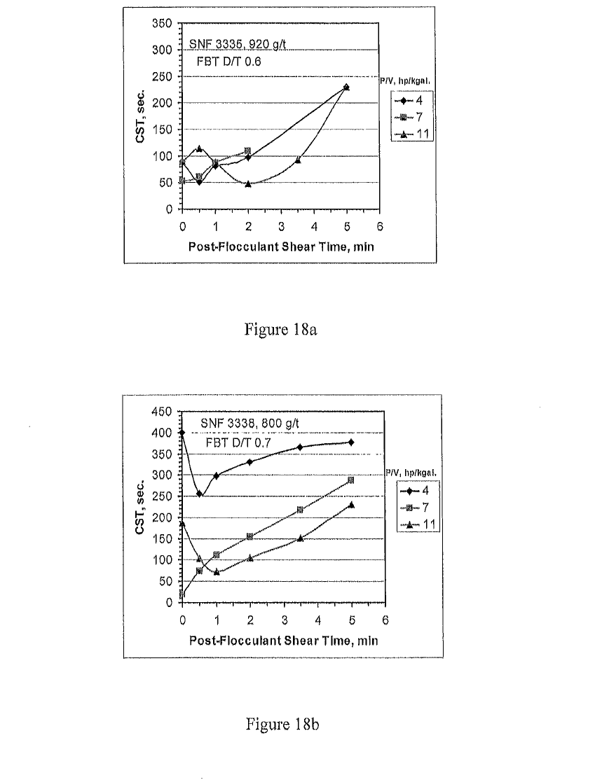

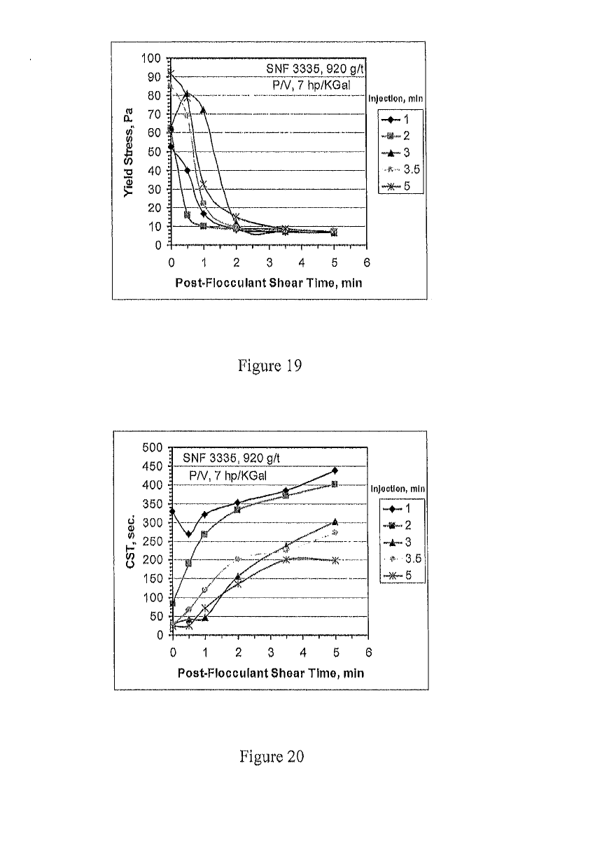

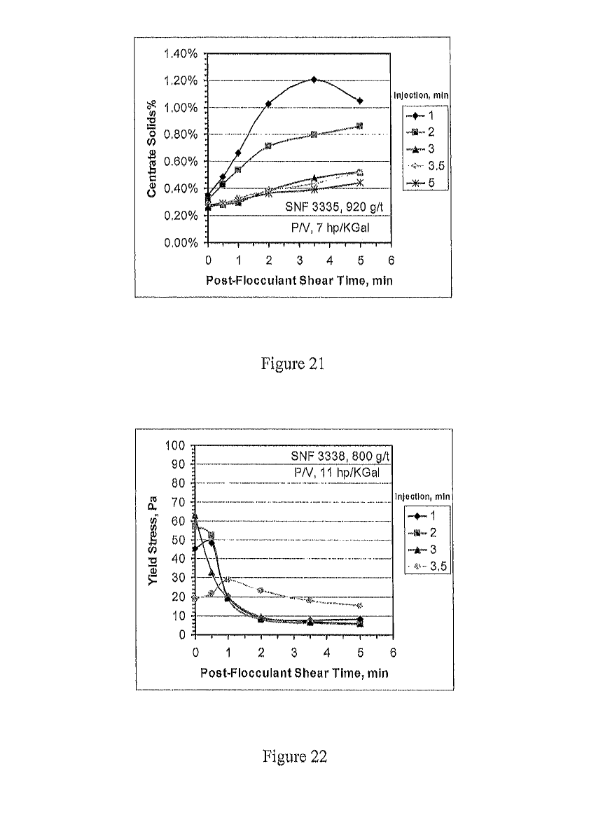

Additional tests using the reaction tank as shown in FIG. 16 were performed to determine the optimal residence time of the flocculant and FFT in a stirred tank (i.e., the optimal flocculant injection/mixing time in the tank). One test was performed using linear anionic acrylamide/acrylate polymer SNF 3335 at a concentration of 0.17% and dosage of 920 g/t. The FFT feed solids content was 20%, H/T 0.6, D/T 0.7, PN 7 hp/kgal, and ambient temperature of 20° C. The effects of flocculant injection/mixing time on yield stresses, CST and centrate solids content at different post-flocculant shear time are shown in FIGS. 19, 20 and 21, respectively. The test data in FIGS. 19, 20 and 21 clearly show that the minimum flocculant injection/mixing time should be about 3 minutes when using a mixing power of 7 hp/kgal. Less than 3 minutes of flocculant injection/mixing time resulted in lower yield stresses, higher CST and higher centrate solids contents. Thus, a flocculant injection time between 3 and 5 minutes was found to be optimal under these conditions.

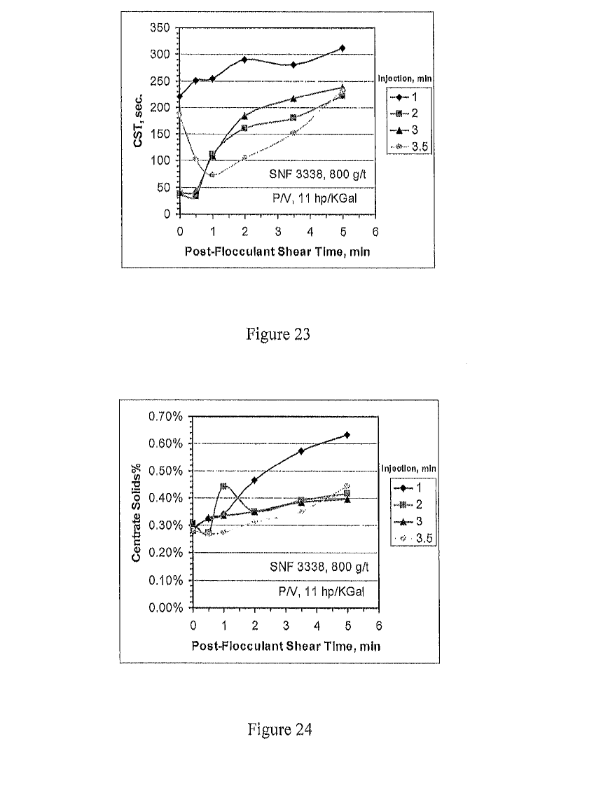

A second test was performed using branched anionic acrylamide/acrylate polymer SNF 3338 at a concentration of 0.4% and dosage of 800 g/t and a higher mixer power (PN) of 11 hp/kgal. The FFT feed solids content was 20%, H/T 0.6, D/T 0.7, and ambient temperature of 20° C. The effects of flocculant injection/mixing time on yield stresses, CST and centrate solids content at different post-flocculant shear time are shown in FIGS. 22, 23 and 24, respectively. The test results show that the minimum flocculant injection/mixing time would be about 2 minutes under higher mixing power of 11 hp/kgal.

### EXAMPLE 3

Polymer dosages were tested using the reactor tank of Example 2. Polymeric flocculant dosage is an important variable for high density FFT flocculation. For this series of tests, both SNF 3335 and SNF 3338 dosages were tested. The fixed test conditions are as follows: FFT feed solids content 20%, H/T 0.6 before flocculant addition, FBT impeller D/T 0.7, PN 7 hp/kgallon, flocculant injection/mixing time 3.5 minutes, and temperature ambient at 20° C.

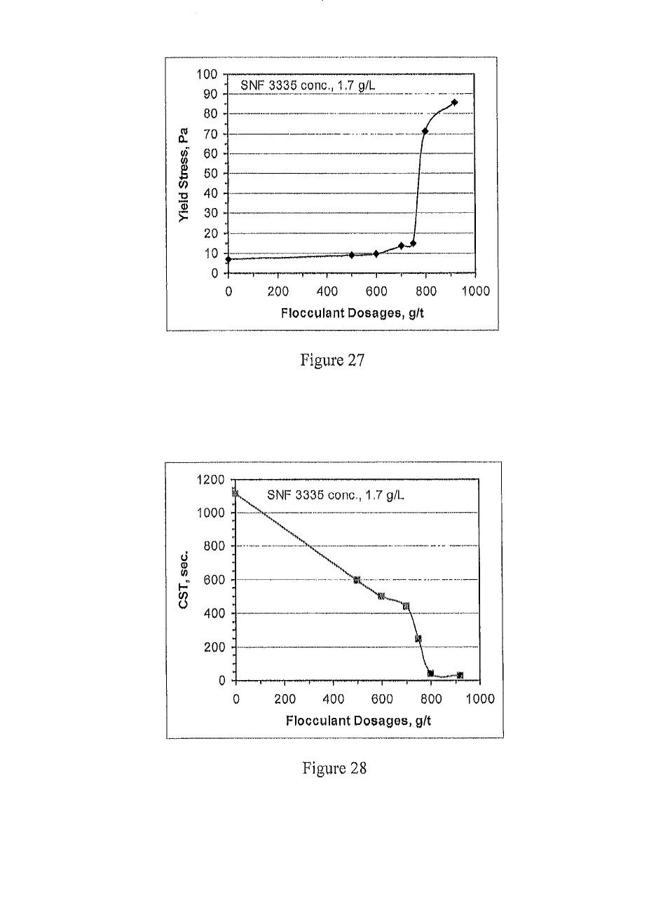

FIGS. 27, 28 and 29 show the effects of SNF 3335 (concentration 1.7 g/L) dosages on yield stresses, CST and centrate solids contents of the flocculated FFT samples at time 0 of post-flocculant shear, respectively. It is clear that the flocculant dosages had tremendous effects on the FFT flocculation performances. When the SNF 3335 dosages were less than 800 g/t, the yield stress in FIG. 27 was very low. However, the yield stress was sharply increased to about 70 Pa at 800 g/t, and then to 85 Pa at 920 g/t. On the other hand, the vane yield stress of the FFT feed without flocculant was about 7 Pa.

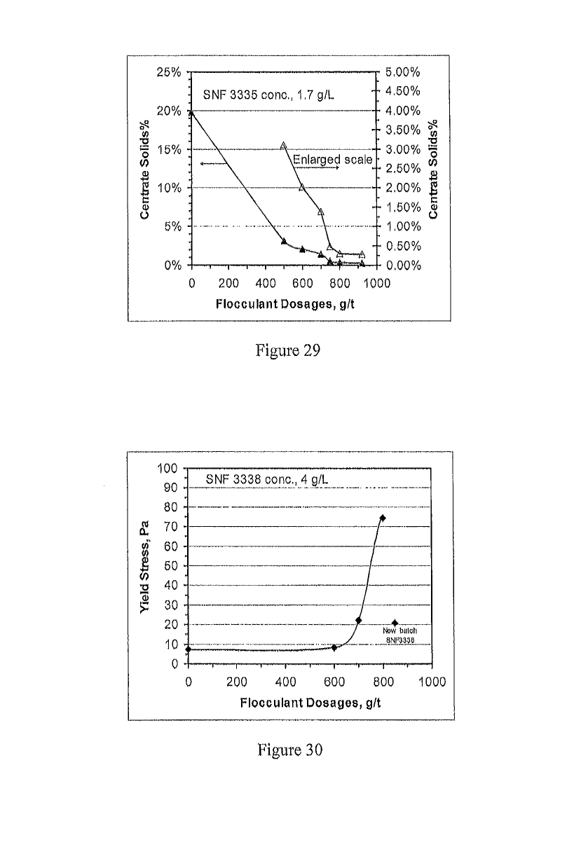

The CST and centrate solids contents in FIGS. 28 and 29 clearly show that increase in SNF 3335 dosages from 0 to 800 g/t gradually decreased the CST and the centrate solids contents. In other words, the dewatering capacity of the flocculated FFT materials was increased. Without flocculant, the CST in FIG. 28 was about 1100 seconds and the centrate solids content was about 20%. These data show that without flocculant treatment, the FFT feed has very poor dewatering capacity and could not be separated by centrifuge at about 1000 G-force. At the dosage of 800 g/t and more, the CST was sharply reduced to 50 seconds and the centrate solids content was reduced to about 0.3%. Therefore, the minimum dosage of SNF 3335 for the 20% FFT feed is about 800 g/t.

FIGS. 30, 31 and 32 show the effects of SNF 3338 (concentration 4 g/L) dosages on yield stresses, CST and centrate solids contents of the flocculated FFT samples at time 0 of post-flocculant shear, respectively. It is clear that the flocculant dosages had tremendous effects on the FFT flocculation performances. When the SNF 3335 dosages were less than 800 g/t, the yield stress in FIG. 30 was very low. However, the yield stress was sharply increased to about 75 Pa at 800 g/t. On the other hand, the vane yield stress of the FFT feed without flocculant was about 7 Pa.

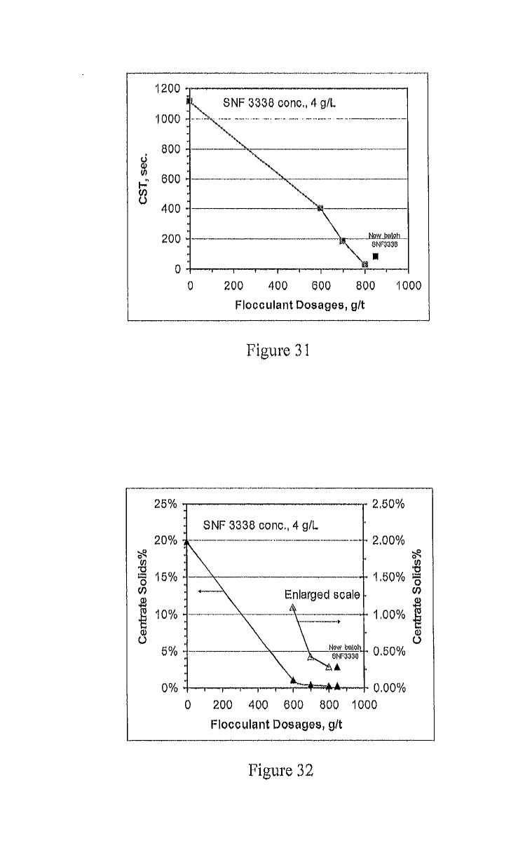

The CST and centrate solids contents in FIGS. 31 and 32 clearly show that increase in SNF 3338 dosages from 0 to 800 g/t gradually decreased the CST and the centrate solids contents. In other words, the dewatering capacity of the flocculated FFT materials was increased. Without flocculant, the CST in FIG. 31 was about 1100 seconds and the centrate solids content was about 20%. These data show that without flocculant treatment, the FFT feed has very poor dewatering capacity and could not be separated by centrifuge at about 1000 G-force. At the dosage of 800 g/t, the CST was sharply reduced to 50 seconds and the centrate solids content was reduced to about 0.3%. Therefore, the minimum dosage of SNF 3338 for the 20% FFT feed is about 800 g/t.

### EXAMPLE 4

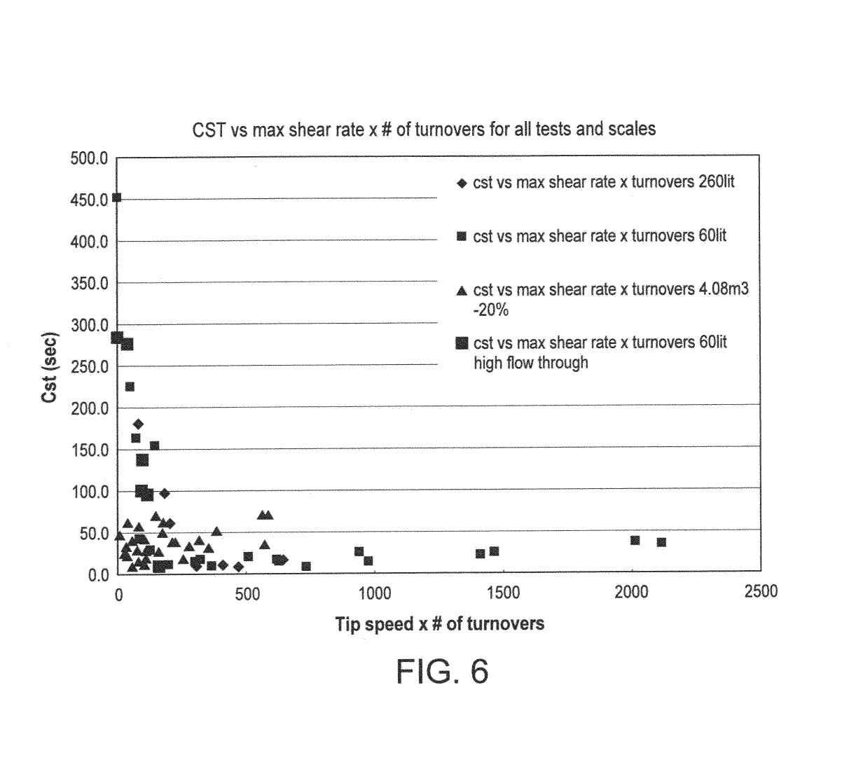

FIG. 6 shows the effect of impeller tip speed times the number of turnovers of the mixture (FFT) for a variety of different sized reactor tanks. The number of turnovers of the mixture means the number of times the mixture circulates in the tank, i.e., the number of times the mixture goes from the bottom of the tank to the top of the tank and back again. The number of turnovers will be dependent upon the size of the tank, the feed rate of the mixture and the impeller tip speed. Thus, the number of turnovers essentially relates to the residence time of the mixture in the tank.

Impeller tip speed can be calculated as follows:

$$\frac{R P M of the impeller}{60} \times impeller diameter ( m ) \times Π ( m \text{/} sec ) .$$

Impeller tip speed is important because it is at this part of the impeller (i.e., tip) where maximum shearing is occurring. Thus, impeller tip speed is directly proportional to the maximum shear rate. Hence, if the feed rate changes or the size of the tank changes, thereby changing the number of turnovers, the impeller tip speed can be adjusted to compensate for these changes and still provide proper conditions for optimum flocculation. As can be seen in FIG. 6, CST is at its lowest point (indicating good dewatering properties) at a tip speed times number of turnovers of about 200 for each of the different sized tanks (260 liters, 60 liters and 4.08 m³) and when high flow through of feed is used, after which time the CST begins to rise, corresponding to poorer dewatering properties of the flocs. This is controlled by adjusting the tip speed accordingly. It can be seen that under 200, there appears to be poor mixing/flocculation as illustrated by the higher CST values, indication poor dewatering capacity.

By way of a hypothetical example, if at a lower flow rate (flow through) of FFT feed into a 60 liter reactor tank the # of turnovers of the FFT is 50, then the tip speed should be about 4 msec in order to achieve a tip speed times number of turnovers of about 200. However, if the flow through into the 60 liter reactor tank of the FFT is increased (i.e., high flow through), the # of turnovers of the FFT may be only 25. Thus, to achieve a tip speed times number of turnovers of about 200, the tip speed would have to be increased to 8 msec. Thus, regardless of the size of the tank or flow rate into the tank, good flocculation and dewatering can be controlled by changing the tip speed accordingly.

### EXAMPLE 5

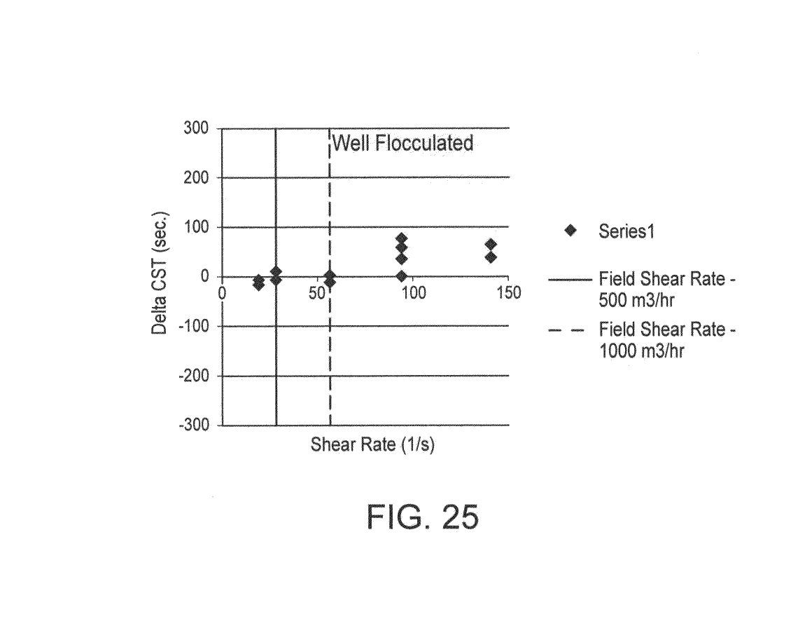

Tests were performed using the above parameters to produce a well flocculated material (using FFT) with good dewatering capabilities (i.e., material having a relatively high yield stress and relatively low CST). The well-flocculated material was then transported through a pipeline to determine whether the well-flocculated material could be transported through a pipe to its final deposition treatment without excessive break-down, i.e., shearing of the flocs. FIG. 25 plots the change in CST (Delta CST) in seconds of the well-flocculated material versus shear rate (1/s). It can be seen that there is very little change in CST of the well-flocculated material over a wide range of shear rates. In fact, under routine field shear rates at flow rates of 500 m3/hr and 1000 m3/hr, respectively, no change in the dewatering property (CST) was observed. Thus, the flocculation reaction of the FFT is completed in the dynamic mixer under the appropriate conditions and, thus, further transport through a pipeline and the like will not change the dewatering properties of the flocculated material.

### EXAMPLE 6

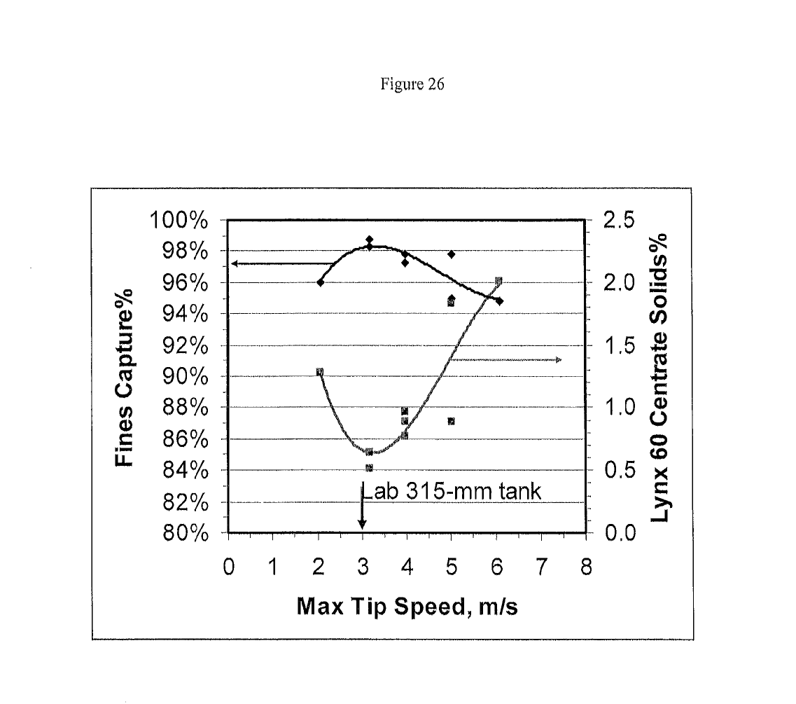

The reactor tank of Example 2 was scaled up for a pilot test and was operated on a continuous basis using FFT fed at a feed rate of 30 msec. A Lynx 60 centrifuge has connected to the reactor tank and the centrifuge centrate solids % and fines capture % determined. A range of tip speeds, m/s, were tested. As can be seen in FIG. 26, the tip speed of 3 m/s resulted in the greatest percentage of fines capture (98.5%) and the lowest percentage of solids (about 0.5%). It is interesting to note that the optimum tip speed for the scaled up tank was the same as for the lab 315 mm tank.

### EXAMPLE 7

In one specific embodiment, a 0.5 m³ multi staged mixing tank with eight compartments and eight flat blade turbine impellers was used to produce a proper flocculated material when fed with 16 wt % FFT. The mixer was attached to a decanter centrifuge that was able to produce a 55 wt % cake at less than 1 wt % solids in the centrate. The mixer was run at 800 RPM and the polymer was injected half way up the vessel at nominally 800 g/tonne. Each impeller diameter was 0.6-0.7 times the tank diameter. The flocculation process in a multi-staged mixer also works on the principal of the impeller tip speed time the number of times the mixtures interacts with the impeller. As the material flows through the vessel it interacts with each impeller as it moves from compartment to compartment. The total experience of the material is the sum of all experiences in each individual compartment.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A process for flocculating and dewatering oil sands fine tailings, comprising:
(i) adding the oil sands fine tailings as an aqueous slurry to a stirred tank reactor;
(ii) adding an effective amount of a polymeric flocculant to the stirred tank reactor containing the oil sands fine tailings and operating the reactor at an impeller tip speed for a period of time that is sufficient to form a gel-like structure;
(iii) subjecting the gel-like structure to shear conditions in the stirred tank reactor for a period of time sufficient to break down the gel-like structure to form flocs and release water; and
(iv) removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

2. The process as claimed in claim 1, wherein the removed flocculated oil sands fine tailings are added to at least one centrifuge to dewater the flocculated oil sands fine tailings and form a high solids cake and a low solids centrate.

3. The process as claimed in claim 1, wherein the removed flocculated oil sands fine tailings are added to a thickener to dewater the flocculated oil sands fine tailings and produce thickened oil sands fine tailings and clarified water.

4. The process as claimed in claim 1, wherein the removed flocculated oil sands fine tailings are transported to at least one deposition cell such as an accelerated dewatering cell for dewatering.

5. The process as claimed in claim 1, wherein the removed flocculated oil sands fine tailings are spread as a thin layer onto a deposition site.

6. The process as claimed in claim 1, wherein the polymeric flocculant is a charged or uncharged polyacrylamide.

7. The process as claimed in claim 1, wherein the polymeric flocculant is a high molecular weight polyacrylamide-sodium polyacrylate co-polymer with about 25-35% anionicity.

8. The process as claimed in claim 7, wherein the polyacrylamide-sodium polyacrylate co-polymers may be branched or linear and have molecular weights which can exceed 20 million.

9. The process as claimed in claim 1, wherein the polymeric flocculant has a molecular weight ranging between about 1,000 kD to about 50,000 kD.

10. The process as claimed in claim 1, wherein the polymeric flocculant is a polysaccharide such as dextran, starch or guar gum.

11. The process as claimed in claim 1, wherein the polymeric flocculant is made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

12. The process as claimed in claim 1, wherein the oil sands fine tailings have a solids content of about 10% to about 70%.

13. The process as claimed in claim 1, wherein the oil sands fine tailings have a solids content of about 15% to about 45%.

14. The process as claimed in claim 1, wherein the oil sands fine tailings are fluid fine tailings.

15. The process of claim 1, wherein the polymeric flocculant is a water soluble polymer having a moderate to high molecular and an intrinsic viscosity of at least about 3 dl/g (measured in 1M NaCl at 25° C.).

16. The process as claimed in claim 1, wherein the polymeric flocculant is in an aqueous solution at a concentration of about between 0.05 and 5% by weight of polymeric flocculant.

17. The process as claimed in claim 1, wherein the polymeric flocculant solution is used at a concentration of about 1 g/L to about 5 g/L.

18. The process as claimed in claim 1, wherein the dosage of polymeric flocculant ranges from 10 grams to 10,000 grams per tonne of oil sands fine tailings.

19. The process as claimed in claim 1, wherein the dosage of polymeric flocculant ranges from about 400 to about 1,000 grams per tonne.
